(19) United States
(12) Patent Application Publication
(10) Pub. No.: US 2007/0288227 A1
(43) Pub. Date: Dec. 13, 2007

(54) EMULATOR MODULE CONTROLLING INPUT/OUTPUT PROCESS OF COMMUNICATION TERMINAL VIA PERIPHERAL DEVICE OF COMPUTER AND METHOD OF OPERATING THE EMULATOR MODULE

(75) Inventors: Jin-Soo Kim, Daejeon (KR); Jae-Wan Jang, Daejeon (KR)

Correspondence Address: HAMMER & HANF, PC, 3125 SPRINGBANK LANE, SUITE G, CHARLOTTE, NC, 28226, US

(73) Assignee: Korea Advanced Institute of Science and Technology

(21) Appl. No.: 11/691,515

(22) Filed: Mar. 27, 2007

(30) Foreign Application Priority Data
Jun. 13, 2006 (KR) 10-2006-0053203

(51) Int. Cl. G06F 9/455

(52) U.S. Cl. 703/24

(57) ABSTRACT

The present invention relates to an emulator module of a computer which controls an input/output process of a communication terminal via a peripheral device interoperating with the computer, and more particularly, to an emulator module of the computer and a method of operating the emulator module which control either a first control signal, transmitted from the peripheral device, to be converted into a second control signal according to a protocol supported by the communication terminal, and to be transmitted to the communication terminal via a communication module of the computer, or a first control signal, received from the communication terminal, to be converted into a second control signal according to a protocol, supported by the peripheral device, and to be transmitted to the peripheral device.

### CROSS-REFERENCE TO RELATED APPLICATION

This application claims the benefit of Korean Patent Application No. 10-2006-0053203, filed on Jun. 13, 2006, in the Korean Intellectual Property Office, the disclosure of which is incorporated herein by reference.

### BACKGROUND OF THE INVENTION

1. Field of the Invention

The present invention relates to an emulator module of a computer which controls an input/output process of a communication terminal via a peripheral device interoperating with the computer, and more particularly, to an emulator module of the computer and a method of operating the emulator module which controls either a first control signal, transmitted from the peripheral device, to be converted into a second control signal according to a protocol supported by the communication terminal, and to be transmitted to the communication terminal via a communication module of the computer or a first control signal, received from the communication terminal, to be converted into a second control signal according to a protocol, supported by the peripheral device, and to be transmitted to the peripheral device.

2. Description of Related Art

Currently, most people carry communication terminals such as a cell phone, and a personal digital assistant (PDA) due to the development and popularization of communication terminals. Accordingly, communications using communication terminals and the number of communication terminal users have increased.

Such communication terminals provide users with a variety of functions as well as existing call services and text message services in order to meet users' needs according to the advance of communication technology and the increase in use of communication terminals.

Generally, communication terminals currently attempt to overcome limited functions of the communication terminals by using predetermined peripheral devices. FIG. 1 illustrates an interoperation among a conventional communication terminal and at least one peripheral device.

Referring to FIG. 1, a communication terminal 110 in the conventional art includes a predetermined application and a communication module. Also, the communication terminal 110 may interoperate with at least one peripheral device 120 such as an input device and output device via a wired/wireless communication channel.

As an example, a user of the communication terminal 110 may perform various input operations in the communication terminal 110 using a keyboard of a computer. For this, a Korean Patent application, Publication No. 2004-0033103 disclosed on Apr. 21, 2004, is provided. In the patent application, a keyboard of a computer and a communication terminal performs a local wireless communication, and the communication terminal outputs predetermined input information, inputted from the keyboard, via the local wireless communication. Also, the communication terminal 110 may directly receive the predetermined input information from the at least one peripheral device 120 for use by only the communication terminal 110 without a relay of the computer. However, according to the conventional art, the user of the communication terminal 110 is required to always carry a corresponding at least one peripheral device 120, such as the keyboard, in order to use the corresponding at least one peripheral device 120.

As another example, the user of the communication terminal 110 may perform various input operations in the communication terminal 110 from the at least one peripheral device 120 of the computer by using an emulator function of the computer. For this, a Korean Patent application, Publication No. 2004-0102623 disclosed on Dec. 8, 2004, is provided. In the patent application, a particular program is installed in the computer and the communication terminal 110, and the at least one peripheral device 120 such as the keyboard or a mouse of the computer is replaced as an input device of the communication terminal 110. However, according to the conventional art, for an interoperation among the communication terminal 110 and the at least one peripheral device 120, the particular program is required to be installed in the communication terminal 110. Specifically, another communication terminal 110 where the particular program is not installed may not interoperate with the at least one peripheral device 120.

Thus, a method (*technological concept/technology idea for interoperation between a communication terminal and at least one peripheral device, without a requirement of always carrying the at least one peripheral device) is required.

### BRIEF SUMMARY

The present invention provides an emulator module of a computer and a method of operating the emulator module which may use a peripheral device of a computer without additionally installing a particular program in a communication terminal supporting a wired/wireless peripheral device, and thereby may enable a user not to carry a peripheral device for only the communication terminal, conveniently extend a limited function of the communication terminal, and control the communication terminal via the peripheral device of the computer.

According to an aspect of the present invention, there is provided an emulator of a computer which controls an input/output process of a communication terminal via at least one peripheral device connected via a wired/wireless communication channel, the emulator including: a peripheral device's event processing module which communicates with at least one device driver corresponding to the at least one peripheral device, and receives a first control signal, transmitted from the at least one peripheral device, via the at least one device driver; and an event conversion module which converts the first control signal into a second control signal according to a protocol supported by the communication terminal, wherein the second control signal is transmitted to the communication terminal via a communication module installed in the computer.

Also, according to an embodiment of the present invention, there is provided an emulator of a computer which controls an input/output process of a communication terminal via at least one peripheral device connected via a wired/wireless communication channel, the emulator including: an event conversion module which converts a first control signal of the communication terminal into a second control signal according to a protocol supported by the at least one peripheral device, the first control signal being received via a communication module installed in the computer; and a peripheral device's event processing module which communicates with at least one device driver corresponding to the at least one peripheral device, and transmits the second control signal, converted in the event conversion module, to the at least one peripheral device via the at least one device driver.

According to another aspect of the present invention, there is provided a method of operating an emulator module of a computer which controls an input/output process of a communication terminal via at least one peripheral device connected via a wired/wireless communication channel, the method including: communicating with at least one device driver corresponding to the at least one peripheral device, and receiving a first control signal, transmitted from the at least one peripheral device, via the at least one device driver; and converting the first control signal into a second control signal according to a protocol supported by the communication terminal, wherein the second control signal is transmitted to the communication terminal via a communication module installed in the computer.

Also, according to an embodiment of the present invention, the method of operating an emulator module of a computer which controls an input/output process of a communication terminal via at least one peripheral device connected via a wired/wireless communication channel, the method including: converting a first control signal of the communication terminal into a second control signal according to a protocol supported by the at least one peripheral device, the first control signal being received via a communication module installed in the computer; and communicating with at least one device driver corresponding to the at least one peripheral device, and transmitting the second control signal, converted in the event conversion module, to the at least one peripheral device via the at least one device driver.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a diagram illustrating a method where a communication terminal supporting a wired/wireless peripheral device uses at least one dedicated peripheral device according to a conventional art;

FIG. 2 is a diagram illustrating an interoperation among a communication terminal, a computer, and at least one peripheral device according to the present invention;

FIG. 3 is a block diagram illustrating a configuration of a computer according to an embodiment of the present invention;

FIG. 4 is a diagram illustrating an example where a computer transmits a first control signal, received from a keyboard, to a communication terminal according to an embodiment of the present invention;

FIGS. 5 and 6 are flowcharts illustrating a method of operating an emulator module according to an embodiment of the present invention; and

FIG. 7 is a diagram illustrating a location of an emulator module according to an embodiment of the present invention.

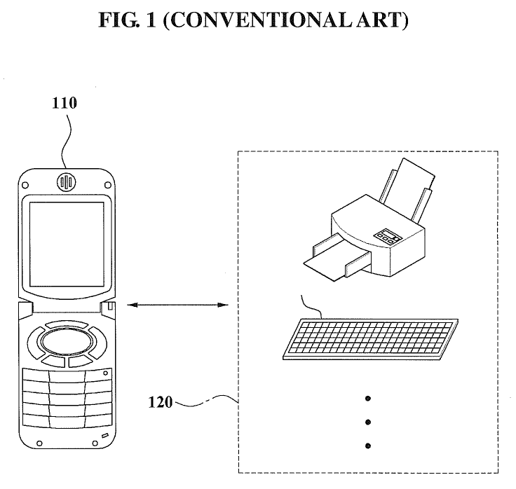

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

A communication terminal used throughout the present invention includes a public switched telephone network (PSTN) terminal, a voice over Internet Protocol (VoIP) terminal, a session initiation protocol (SIP) terminal, a media gateway control (Megaco) terminal, a personal digital assistant (PDA), a mobile phone, a personal communication service (PCS) phone, a hand-held personal computer (hand-held PC), a code-division multiple access (CDMA)-2000 (1×, 3×) phone, a wideband code-division multiple access (wideband CDMA) phone, a dual band/dual mode phone, a Global System for Mobile Communication (GSM) phone, a mobile broadband system (MBS) phone, or a satellite/terrestrial digital multimedia broadcasting (DMB) phone, and the like.

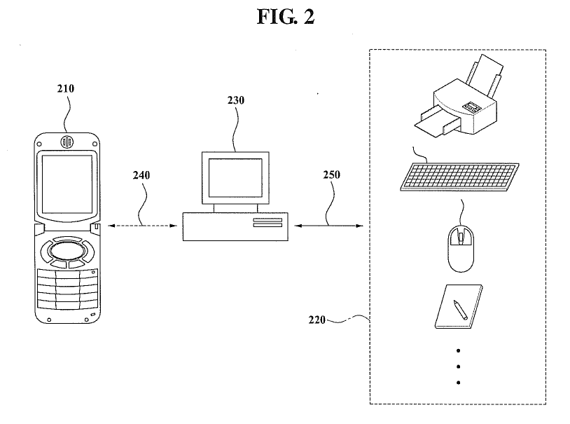

FIG. 2 is a diagram illustrating an interoperation among a communication terminal, a computer, and at least one peripheral device according to the present invention.

Referring to FIG. 2, a communication terminal 210 sets a communication channel 240 with a computer 230 to interoperate with at least one peripheral device 220. For this, the communication terminal 210 and the computer 230 maintain a predetermined communication module. The communication module is at least one communication module supported by the communication terminal 210, and may use a local wired communication module or a local wireless communication module. In this instance, the local wired communication module may include a universal serial bus (USB) port and a serial port, and the local wireless communication module may include a Bluetooth communication module, an infrared communication module, a wireless local area network (WLAN) module, an ultra wideband (UWB) communication module, and a Zigbee communication module.

The computer 230 is connected to the at least one peripheral device 220 via a wired/wireless communication channel 250. Also, the computer 230 receives a predetermined first control signal via at least one device driver corresponding to the at least one peripheral device 220. In this instance, the first control signal is generated from the at least one peripheral devices 220. The computer 230 generates a second control signal by converting the first control signal according to a protocol of the communication channel 240. Also, the computer 230 transmits the second control signal to the communication terminal 210 via the communication channel 240. Accordingly, the communication terminal 210 performs a predetermined control operation according to the first control signal inputted from the at least one peripheral device 220.

As an example, when receiving a particular key from a keyboard of the at least one peripheral device 220, the computer 230 converts the particular key according to a protocol of the communication channel 240, and transmits the particular key, which is converted according to the protocol, to the communication terminal 210. Accordingly, the communication terminal 210 performs a function defined in the communication terminal 210 such as outputting the particular key to a display unit according to the inputted key.

Also, the computer 230 may receive the first control signal from the communication terminal 210 via the communication channel 240. Accordingly, the computer 230 generates the second control signal by converting the first control signal according to a protocol of the communication channel 240. The second control signal is transmitted to the at least one peripheral device 220 via the at least one device driver corresponding to the at least one peripheral device 220 in order to be transmitted to a particular peripheral device of the at least one peripheral device 220. As an example, when outputting predetermined data via a printer of the at least one peripheral device 220, the communication terminal 210 transmits the first control signal to the computer 230 via the communication channel 240. The computer 230 converts the first control signal, according to a protocol of the communication channel 240, into the second control signal. Also, the computer 230 transmits the second control signal to the printer via a device driver of the printer. Thus, the printer may perform an output operation.

Specifically, according to the present invention, the communication terminal 210 is controlled by the at least one peripheral device of the computer 230, without requiring a peripheral device for exclusive use by the communication terminal 210. In this instance, the at least one peripheral device of the computer 230 is located around a user and the user may use the at least one peripheral device of the computer 230. Accordingly, a function of the communication terminal 210 may be conveniently used. Also, the at least one peripheral device 220 of the computer 230 is controlled by the communication terminal 210, and thus, a limited function of the communication terminal 210 may be conveniently and efficiently extended.

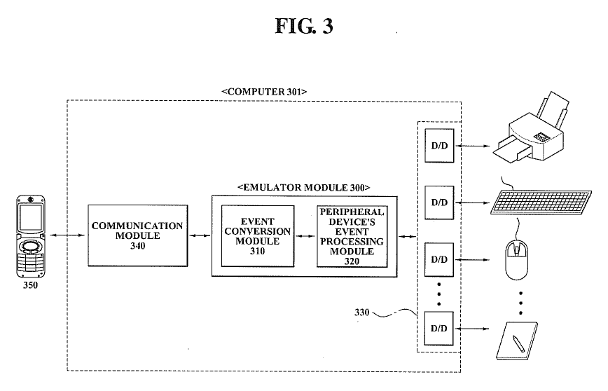

FIG. 3 is a block diagram illustrating a configuration of a computer according to an embodiment of the present invention.

Referring to FIG. 3, a computer 301 maintains an emulator module 300 to interoperate with at least one peripheral device and a communication terminal 350 connected via a wired/wireless communication channel.

The emulator module 300 according to an embodiment of the present invention may include an event conversion module 310 and a peripheral device's event processing module 320.

The peripheral device's event processing module 320 communicates with at least one device driver 330 corresponding to the at least one peripheral device, and receives a first control signal, transmitted from the at least one peripheral device, via the at least one device driver 330. Also, the event conversion module 310 converts the first control signal into a second control signal according to a protocol supported by the communication terminal 350.

Specifically, the at least one device driver 330 converts input information, inputted from the at least one peripheral device, such as a keyboard, a mouse, or a touch pad, into the first control signal such as an event or data. The peripheral device's event processing module 320 collects the processed first control signal, and forwards the first control signal to the event conversion module 310. The event conversion module 310 converts the first control signal into a second control signal according to a protocol supported by a communication module of the communication terminal 350, in order to transmit the first control signal to the communication terminal 350 via the communication module 340.

The communication module 340 according to an embodiment of the present invention may be a local wired communication module or a local wireless communication module. In this instance, the local wired communication module may include a USB port and a serial port, and the local wireless communication module may include a Bluetooth communication module, an infrared communication module, a WLAN module, a UWB communication module, and a Zigbee communication module. Specifically, the event conversion module 310 converts the first control signal to transmit the second control signal via the local wired communication module or the local wireless communication module.

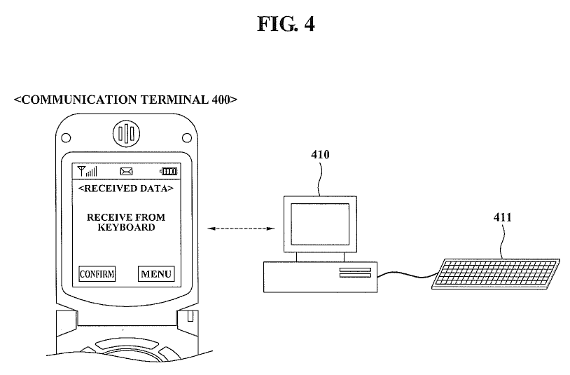

The converted second control signal is transmitted to the communication terminal 350 via the communication module 340. The communication terminal 350 which receives the second control signal performs a predetermined control operation. An operation where the communication terminal 350 receives the second control signal from the communication module 340 of the computer 301 and performs the predetermined control operation is described in detail with reference to FIG. 4.

FIG. 4 is a diagram illustrating an example where a computer transmits a first control signal, received from a keyboard, to a communication terminal according to an embodiment of the present invention.

Referring to FIG. 4, a computer 410 receives a combination of letters, ‘receive from keyboard’, i.e. a first control signal, from a keyboard 411. In this instance, the keyboard is a peripheral device. An emulator module which is maintained by the computer 410 converts the first control signal into a second control signal according to a protocol corresponding to a communication module which is maintained by a communication terminal 400. Accordingly, the computer 400 transmits the second control signal to the communication terminal 400 via a predetermined communication module. The communication terminal 400 which receives the second control signal outputs the second control signal to a display unit. Specifically, the communication terminal 400 outputs the ‘receive from keyboard’ via the display unit, such as a liquid crystal display (LCD), according to the second control signal including the combination of letters, ‘receive from keyboard’ which is received from the computer 410.

In FIG. 3, the at least one peripheral device may perform the predetermined control operation via the first control signal transmitted from the communication terminal 350.

For this, the event conversion module 310 converts the first control signal of the communication terminal 350 into the second control signal according to a protocol supported by the at least one peripheral device. In this instance, the first control signal of the communication terminal 350 is received via the communication module 340 installed in the computer 301. Also, the peripheral device's event processing module 320 communicates with the at least one device driver 330 corresponding to the at least one peripheral device, and transmits the second control signal, converted in the event conversion module 310, to the at least one peripheral device via the at least one device driver 330.

As an example, the communication terminal 350 transmits voice and sound data to a speaker, which is included in the at least one peripheral device and connected to the computer 301, and thus a sound from the communication terminal 350 may be heard in the speaker connected to the computer 301. The communication terminal 350 transmits the voice and sound data, i.e. the first control signal, to the communication module 340 of the computer 301 via a predetermined communication module. The communication module 340 which receives the first control signal forwards the first control signal to the event conversion module 310 of the emulator module 300. The emulator module 300 converts the first control signal into the second control signal according to the protocol supported by the at least one peripheral device. Also, the peripheral device's event processing module 320 forwards the converted second control signal to the at least one device driver 330 which is required for operating the speaker. The at least one device driver 330 controls the speaker according to the received second control signal, and plays the voice and sound data.

The emulator module 300 according to an embodiment of the present invention may be embodied in an Operating System (OS) level of the computer 301 or in a form of an application operated in an Operating System of the computer 301.

Thus, a user may control the communication terminal 350 via the at least one peripheral device of the computer 301 without separately installing a program in the communication terminal 350, via the emulator module 300 included in the computer 301 according to the present invention. Also, the user may control the at least one peripheral device of the communication terminal 350 without separately installing a program in the communication terminal 350. Through this, the user is not require to carry the at least one peripheral device for the communication terminal for a functional extension of the communication terminal 350.

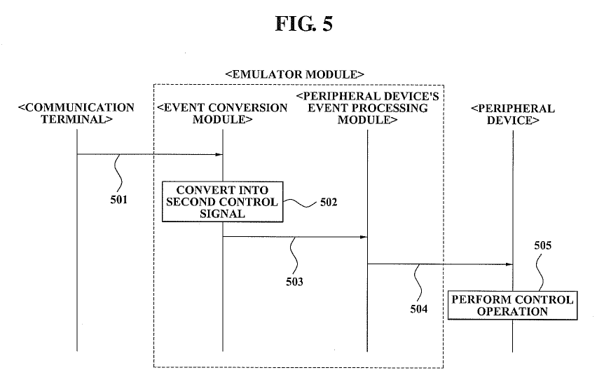

FIG. 5 is a flowchart illustrating a method of operating an emulator module according to an embodiment of the present invention.

Referring to FIG. 5, in operation 501, a communication terminal transmits a first control signal to a communication module of a computer via a wired/wireless communication, and the computer forwards the first control signal to an event conversion module of the emulator module. In operation 502, the event conversion module converts the first control signal into a second control signal according to a protocol supported by a peripheral device. In operation 503, a peripheral device's event processing module receives the second control signal. In operation 504, the peripheral device's event processing module transmits the second control signal to the peripheral device via at least one device driver, corresponding to the second control signal, from a plurality of device drivers. In operation 505, a predetermined control operation is performed according to the second control signal.

As an example, the peripheral device is a printer, and the first control signal is picture data which is maintained by the communication terminal. Specifically, the communication terminal transmits the picture data, stored in a memory unit, and an output control signal of the picture data, as the first control signal to the computer via a local wired communication module or a local wireless communication module. The computer forwards the first control signal to the event conversion module by buffering the first control signal. The event conversion module converts the first control signal so that the first control signal may be outputted via a device driver of the printer. The peripheral device's event processing module confirms whether the second control signal includes the picture data to be outputted to the printer or the output control signal. Also, the peripheral device's event processing module forwards the second control signal to the device driver corresponding to the printer. Accordingly, the device driver controls the picture data to be outputted to the printer according to the second control signal.

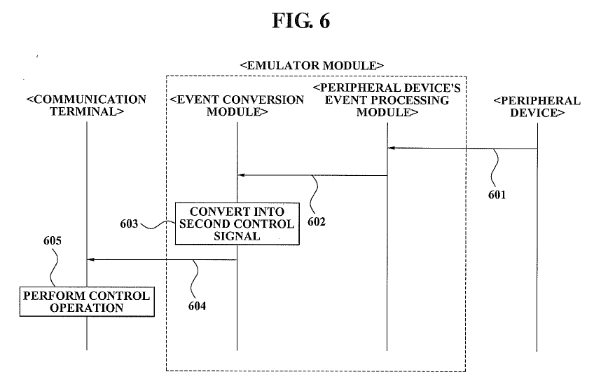

FIG. 6 is a flowchart illustrating a method of operating an emulator module according to an embodiment of the present invention.

Referring to FIG. 6, in operation 601, a peripheral device forwards a first control signal to a device driver of a computer, and the device driver forwards the first control signal to a peripheral device's event processing module of the emulator module. In operation 602, the first control signal is forwarded to an event conversion module. In operation 603, the event conversion module converts the first control signal into a second control signal according to a protocol supported by a communication terminal.

In operation 604, the event conversion module controls a communication module of the computer to transmit the second control signal to the communication terminal. In operation 605, the communication terminal receives the second control signal and performs a predetermined control operation.

As an example, the peripheral device is a touch pad, and the first control signal is information inputted in the touch pad by a user. Specifically, the user inputs the information such as a predetermined drawing, character, or number, to the touch pad via an input device such as a pen, fingers, and the like. The inputted information is collected in the peripheral device's event processing module as the first control signal. The collected first control signal is converted into a protocol which is compatible with the communication terminal, in the event conversion module, and is processed to the second control signal. The processed second control signal is transmitted to the communication terminal via the communication module of the computer. The communication terminal performs the predetermined process operation according to the second control signal in operation 605.

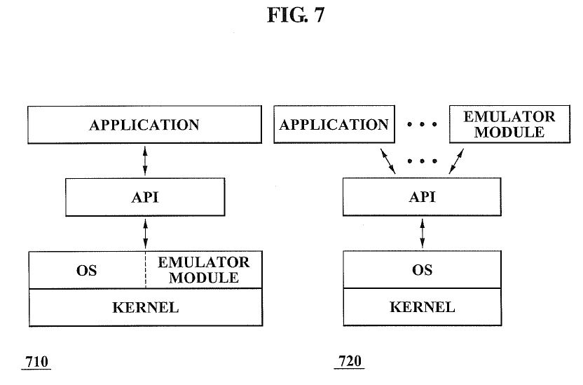

FIG. 7 is a diagram illustrating a location of an emulator module according to an embodiment of the present invention.

An example of the emulator module included in an Operating System level of a computer 710 is illustrated in FIG. 7. When the emulator module is included in the Operating System level of the computer 710 as illustrated in FIG. 7, the emulator module directly transmits and receives an event or data with a device driver of a peripheral device and performs above-described operations.

An example where the emulator module is embodied in a form of an application operated in the Operating System of another computer 720 is illustrated in FIG. 7. When the emulator module is embodied in a form of an application operated in the Operating System of the other computer 720 as illustrated in FIG. 7, a modification is not required in a conventional Operating System. Also, the application is a user space, and thus a user may conveniently perform a management operation such as installation, a modification, or a deletion of the emulator module.

The above-described embodiment of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the present invention, an emulator module of a computer and a method of operating the emulator module control a communication terminal by a peripheral device of the computer, and thereby may easily use a function of the communication terminal.

Also, according to the present invention, an emulator module of a computer and a method of operating the emulator module control a peripheral device of the computer by a communication terminal, and thereby may conveniently and efficiently extend a limited function of the communication terminal.

Also, according to the present invention, an emulator module of a computer and a method of operating the emulator module may interoperate with a peripheral device of the computer and a communication terminal without installing a additional program in the communication terminal.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An emulator of a computer which controls an input/output process of a communication terminal via at least one peripheral device connected via a wired/wireless communication channel, the emulator comprising:
a peripheral device's event processing module which communicates with at least one device driver corresponding to the at least one peripheral device, and receives a first control signal, transmitted from the at least one peripheral device, via the at least one device driver; and
an event conversion module which converts the first control signal into a second control signal according to a protocol supported by the communication terminal,
wherein the second control signal is transmitted to the communication terminal via a communication module installed in the computer.

2. An emulator of a computer which controls an input/output process of a communication terminal via at least one peripheral device connected via a wired/wireless communication channel, the emulator comprising:
an event conversion module which converts a first control signal of the communication terminal into a second control signal according to a protocol supported by the at least one peripheral device, the first control signal being received via a communication module installed in the computer; and
a peripheral device's event processing module which communicates with at least one device driver corresponding to the at least one peripheral device, and transmits the second control signal, converted in the event conversion module, to the at least one peripheral device via the at least one device driver.

3. The emulator of claim 1, wherein the peripheral device is a wired/wireless keyboard connected to the computer.

4. The emulator of claim 2, wherein the at least one peripheral device is any one of: a printer, a mouse, a speaker, a microphone, a headset, or any combination thereof connected to the computer.

5. The emulator of claim 1 wherein the communication module is a local wired communication module corresponding to any one of: a universal serial bus (USB) port, a serial port, or a combination thereof.

6. The emulator of claim 1 wherein the communication module is a local wireless communication module corresponding to any one of: a Bluetooth communication module, an infrared communication module, a wireless local area network (WLAN) module, a ultra wideband (UWB) communication module, a Zigbee communication module, or any combination thereof.

7. The emulator of claim 1 wherein the emulator is included in an Operating System (OS) level of the computer.

8. The emulator of claim 1 wherein the emulator is embodied in a form of an application operated in an Operating System of the computer.

9. The emulator of claim 1 wherein the communication terminal is any one of: a mobile communication terminal, a public switched telephone network (PSTN) terminal, a voice over Internet protocol (VoIP) terminal, a session initiation protocol (SIP) terminal, a media gateway control (Megaco) terminal, a personal digital assistant (PDA), a mobile phone, a personal communication service (PCS) phone, a hand-held personal computer (PC), a Code Division Multiple Access (CDMA)-2000 (1×, 3×) phone, a Wideband CDMA phone, a dual band/dual mode phone, a Global System for Mobile Communications (GSM) phone, a mobile broadband system (MBS) phone, a satellite/terrestrial Digital Multimedia Broadcasting (DMB) phone, or any combination thereof.

10. A method of operating an emulator module of a computer which controls an input/output process of a communication terminal via at least one peripheral device connected via a wired/wireless communication channel, the method comprising:
communicating with at least one device driver corresponding to the at least one peripheral device, and receiving a first control signal, transmitted from the at least one peripheral device, via the at least one device driver; and
converting the first control signal into a second control signal according to a protocol supported by the communication terminal,
wherein the second control signal is transmitted to the communication terminal via a communication module installed in the computer.

11. A method of operating an emulator module of a computer which controls an input/output process of a communication terminal via at least one peripheral device connected via a wired/wireless communication channel, the method comprising:
converting a first control signal of the communication terminal into a second control signal of the communication terminal according to a protocol supported by the at least one peripheral device, the first control signal being received via a communication module installed in the computer; and
communicating with at least one device driver corresponding to the at least one peripheral device, and transmitting the second control signal, converted in the event conversion module, to the at least one peripheral device via the at least one device driver.

12. A computer-readable recording medium storing a program for implementing a method of operating an emulator module of a computer which controls an input/output process of a communication terminal via at least one peripheral device connected via a wired/wireless communication channel, the method comprising:
communicating with at least one device driver corresponding to the at least one peripheral device, and receiving a first control signal, transmitted from the at least one peripheral device, via the at least one device driver; and
converting the first control signal into a second control signal according to a protocol supported by the communication terminal,
wherein the second control signal is transmitted to the communication terminal via a communication module installed in the computer.

13. A computer-readable recording medium storing a program for implementing a method of operating an emulator module of a computer which controls an input/output process of a communication terminal via at least one peripheral device connected via a wired/wireless communication channel, the method comprising:
converting a first control signal of the communication terminal into a second control signal according to a protocol supported by the at least one peripheral device, the first control signal being received via a communication module installed in the computer; and
communicating with at least one device driver corresponding to the at least one peripheral device, and transmitting the second control signal, converted in the event conversion module, to the at least one peripheral device via the at least one device driver.
